(19) United States
(12) Patent Application Publication
(10) Pub. No.: US 2008/0168664 A1
(43) Pub. Date: Jul. 17, 2008

(54) Rotary trimmer head with advancing system having rounded tangs

(75) Inventor: Fernando R. Iacona, Paradise Valley, AZ (US)

Correspondence Address: CASELLA & HESPOS, 274 MADISON AVENUE, NEW YORK, NY, 10016, US

(73) Assignee: Kwik Products, Inc., Phoenix, AZ (US)

(21) Appl. No.: 12/008,023

(22) Filed: Jan. 8, 2008

Related U.S. Application Data
(60) Provisional application No. 60/880,874, filed on Jan. 17, 2007.

(51) Int. Cl. B26B 7/00; B26B 9/00

(52) U.S. Cl. 30/276; 30/347

(57) ABSTRACT

An improved feedout mechanism for the cutting head of a rotary trimmer includes curved surfaces on the top of the lower row of the cam tangs which replace the original flat surfaces of the lower row of cam tangs in the prior art cutting head. Also, the lower surface of each follower tang also has a curved surface which is changed from the original flat design in the prior art. The curved surfaces of the follower tangs and the cam tangs facilitate the line advancement operation and prevents the follower tangs from being hung up with the cam tangs.

This application claims priority to an application entitled “ROTARY TRIMMER HEAD WITH ADVANCING SYSTEM HAVING ROUNDED TANGS” filed in the United States Patent and Trademark Office on Jan. 17, 2007 and assigned Ser. No. 60/880,874, the contents of which are hereby incorporated by reference.

### BACKGROUND OF THE INVENTION

1. Field of the Invention

The subject invention relates generally to cutting heads for rotary trimmers. More specifically, it relates to an improved cutting head for rotary trimmers using monofilament string as a means for cutting vegetation. The subject invention represents an improvement over existing designs as it allows a smoother feedout of the monofilament string as required by the operator of the trimmer and smoother operation of the trimmer head. The subject invention is an improvement over the invention of U.S. Pat. No. 6,735,874 B2 which issued on May 18, 2004 and is assigned to the assignee of the subject application.

2. Description of the Prior Art

Cutting heads for rotary trimmers are well known in the art and have been the subject of previous United States patents. Most relevant to the subject invention are U.S. Pat. Nos. 4,259,782; 4,458,419; 4,097,991 and 4,959,904 which issued to Proulx, the disclosures of which are incorporated herein by reference. Most relevant to the subject invention is applicant's U.S. Pat. No. 6,735,874 B2 which is referred to above.

The Proulx patents disclose a flail feedout mechanism for a rotary trimmer that comprises a spinning housing that contains a spool of filament, a plurality of orifices for extending the filaments outwardly into the cutting position and a means that normally restricts movement between the spool and the housing, or can be released at a predetermined rotational distance so that additional filament length can be fed out of the orifice. The means is generally referred to as an advancing mechanism in the art.

Proulx's advancing mechanism for restricting filament feedout includes, as part of the spool, a downwardly projecting bumper that normally spaces the exposed filament above the surface being cut. The spool, bumper, and an intermediate member, as an assembly, are spring loaded downwardly with respect to the spinning housing. A plurality of tangs extend inwardly from the intermediate cylinder that rides in a serpentinous cam slot in a cam member fixed to the housing. When the bumper is bumped on the ground, the intermediate cylinder is moved upwardly so that its tangs ride up relatively vertical cam surfaces until they reach spiral surfaces that extend downwardly to the next vertical cam surfaces. The net effect is that the spool, connected to the cam member, rotates relative to each other to allow a predetermined length of filament string to feed out by centrifugal force. Since a serpentinous cam is used, a single bump feeds out a single segment of filament.

However, the Proulx designs are flawed in that the feedout mechanism does not operate smoothly resulting in erratic and jerky operation. In addition, the tangs on certain advancing mechanisms of the Proulx designs are subject to breakage, thereby compromising the structural integrity of the Proulx designs. The erratic and jerky operation of the Proulx designs is uncomfortable for the user and can potentially cause the filament to feedout unevenly or even jam.

The shortcomings of the Proulx designs are overcome by applicant's invention of U.S. Pat. No. 6,735,874 B2, the disclosure of which is incorporated herein in its entirety by reference. The cutting head of applicant's rotary trimmer of U.S. Pat. No. 6,735,874 B2 is an improvement upon the feedout mechanism of the Proulx U.S. Pat. No. 4,259,782 and employs the same basic structural architecture. In applicant's rotary trimmer, the trimmer includes a hollow handle with an attached drive means that is connected to a spring housing. The housing has a spool containing one or more coils of string used as filaments for cutting vegetation. A pair of orifices is oppositely positioned on the spool for guiding the exposed filament to the proper cutting position.

The advancing mechanism of applicant's U.S. Pat. No. 6,735,874 B2 contains a follower member having a number of tangs that have a base that is wider than the rounded end to form a taper from the base to the tip. In effect, the configuration of applicant's follower tangs are of generally truncated, bell-shaped configuration. The follower member is coupled to a cam having offset tangs for controlling the amount of string feedout of the cutting head to a predetermined length. The tangs of the cam also have a base that is wider than the rounded tip to form a taper from base to tip and is also effectively of truncated, bell-shaped configuration. This configuration results in better force distribution when the tangs of the follower and the tangs of the cam engage each other, thereby causing a smoother feedout of the filament and a sturdier trimmer head. A biasing spring maintains the follower member and the cam of U.S. Pat. No. 6,735,874 properly positioned within the housing so that string is only fed out when the housing is momentarily bounced on the ground.

Although the trimmer head of applicant's U.S. Pat. No. 6,735,874 B2 operates satisfactorily and is an improvement over prior existing trimmer heads, under certain conditions of speed and load, in particular, when applicant's prior trimmer head was tapped on the ground to release more line, and while the trimmer line was not contacting any vegetation, certain problems developed. On rare occasions it was possible for the follower tangs to rest on top of the flat surface of the lower row of cam tangs. At that position, the follower tangs remain stuck on the cam tangs until the trimmer head was tapped on the ground a second time. The normal force of the compression spring attempting to push the follower member downwardly over the cam member would create friction between the lower flat surface of the follower tangs and the upper flat surface of the lower row of cam tangs. This friction was sufficient to keep the follower member lightly stuck in the upward position, such that under light engine load of the trimmer, and when the trimming line was not in contact with vegetation (a condition typical at the moment when line is being advanced), the normal torsional vibration of the machine was not sufficient to shake the follower loose. As such, the follower could not return to its downward position to complete the line advancement operation.

Accordingly, it is an object of the subject invention to provide a new and improved advancing system for a trimmer head which prevents the follower member from being stuck in the upward position on the cam member, as occurred occasionally in connection with the trimmer head of applicant's U.S. Pat. No. 6,735,874 B2.

It is a further object of the subject invention to provide a cutting head that has a smooth feedout mechanism.

It is another object of the subject invention to provide a cutting head that can be retrofitted onto existing rotary trimmers.

Still a further object of the subject intention is to provide a cutting head that is simple, low-cost to manufacture, and of sturdier construction and smoother operation than prior art cutting heads.

These and other objects of the subject invention will become apparent to those of skill in the art from the accompanying drawings and the following detailed description.

### SUMMARY OF THE INVENTION

The cutting head for a rotary trimmer of the subject invention is an improvement upon the feedout mechanism of U.S. Pat. No. 6,735,874 and employs the same basic structural architecture. Briefly, the advancing system of the subject invention includes curved surfaces on the top of the lower row of the cam tangs which replace the original flat surfaces of the lower row of cam tangs. These four curved cam surfaces are the only things that are changed from the cam design of U.S. Pat. No. 6,735,874 B2. The lower surface of each follower tang has also been changed from the design in applicant's U.S. Pat. No. 6,735,874 in that each lower surface of each follower tang has a curved surface which has been changed from the original flat design.

Because of the curved surfaces of the follower tangs and the lower row of cam tangs in the subject invention, the downward force of the compression spring acting on these curved surfaces now forces the follower to continue rotating so that it can complete the line advancement operation and return to its downward position. Because both the lower row of cam tangs and the follower tangs are curved, it now becomes extremely unlikely, in fact nearly impossible, for the follower member to come to rest in a position that would allow it to set or stall on top of the upper surface of the lower row of curved cam tangs.

Another equally important benefit of the subject invention is that the curved surfaces of the follower tangs and the lower row of cam tangs make it easier for the follower to accomplish its first few degrees of rotation immediately after the initial upward movement which initiates the line advancement operation.

Another benefit achieved by the subject invention is that the new curved design of both the lower row of the cam tangs and the follower member results in plastic having been removed from the lower corners of the follower tangs and from the upper corners of the lower row of cam tangs. This removal of plastic was required in order to convert the previously flat surfaces into curved surfaces. This removal of plastic from where it used to be has created additional clearance space in the advancing mechanism, greatly improving its freedom of movement, and with almost no sacrifice in the strength of the follower tangs and lower row of cam tangs. It should be noted, as shown in the drawings of the subject invention, that the respective curved surfaces of the follower tangs and the cam tangs are dome shaped to facilitate the smooth operation of the subject invention.

### BRIEF DESCRIPTION OF THE DRAWINGS

FIG. 1 is an exploded perspective view of the prior art flail feedout assembly of U.S. Pat. No. 6,735,874 B2;

FIG. 2 is a exploded perspective view of the new and improved follower and cam members of the subject invention;

FIG. 3 is a side elevational view of the cam assembly of FIG. 2 as viewed along line 3-3 in FIG. 2;

FIG. 4 is a cross-sectional view of the follower member of FIG. 2 taken along line 44 of FIG. 2;

FIG. 5 is another exploded perspective view of the follower and cam members of the subject invention, taken from the bottom side thereof;

FIG. 6 is a perspective view of the follower and cam assemblies of the subject invention in the normal driving (downward) position;

FIG. 7 is a perspective view of the follower and cam members of the subject invention at the midpoint of advancing (upward) position;

FIG. 8 is a perspective view, partially in section, of the follower and cam members in the advanced (upward) position, as in FIG. 7; and

FIG. 9 is a side elevational view, partially in section, taken along line 9-9 in FIG. 8.

### DETAILED DESCRIPTION OF THE PREFERRED EMBODIMENT

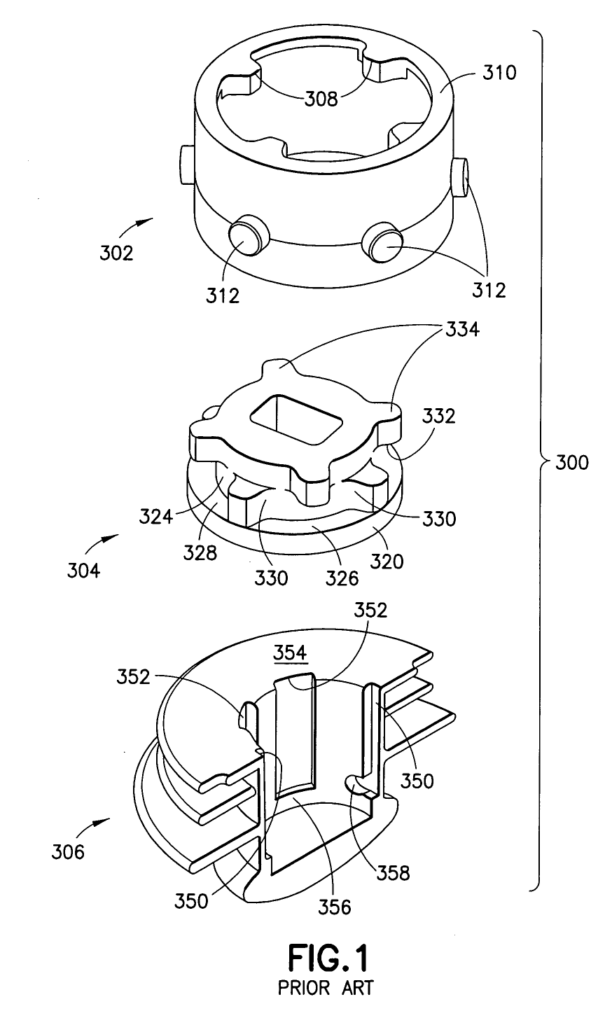

Turning to FIG. 1, there is illustrated the flail feedout mechanism or assembly according to applicant's prior invention of U.S. Pat. No. 6,735,874 B2. The prior art flail feedout mechanism assembly 300, as illustrated in FIG. 1, basically comprises a follower member 302, a cam member 304, and a spool member 306. The follower member 302 is of generally cylindrical configuration having four uniformly spaced tangs 308 adjacent to the upper surface 310 of the follower member 302. Projecting radially outwardly of the follower member 302, and uniformly spaced, are six knobs, each designated by the numeral 312.

As noted in the detailed description of U.S. Pat. No. 6,735,874 B2, the upper and lower surfaces of each tang 308 is planar.

Cam member 304 has a lower, annular plate 320 of a diameter slightly less than the inner diameter of the cylindrical follower member 302. Formed integral with the plate 320, and formed adjacent the upper surface of the cam member 304, is a serpentinous cam groove 324. The cam groove 324 has radially oriented lower surfaces 326, 328 and a lower row of tangs 330. The upper surface 332 of the cam groove 324 is formed by an upper row of tangs 334.

The spool member 306 includes six grooves 350, 352 in its inner cylindrical surface 354. The grooves 350 are diametrically opposed and axially aligned within the spool member 306 and extend from the top surface 354 of the spool member 306 down to a radially oriented abutment surface 356 having lateral cutouts 358 adjacent thereto. The grooves 350 receive two outwardly extending, diametrically opposed knobs 312 which slide therealong and lock the follower member 302 to which the knobs 312 are mounted to rotate with the spool member 306. The grooves 352 also extend from the top surface 354 of the spool member 306 down to the radially oriented abutment surface 356, with the width of each groove 354 corresponding to the maximum width of the grooves 350, including the lateral cutouts 358. Accordingly, in the locked position of the follower member 302 in the spool member 306, each of the six knobs 312 bears against a sidewall of the respective grooves 350, 352, thereby providing enhanced structural contact between the follower member 302 and the spool member 306 so as to improve the efficiency and smoothness of operation of the flail feedout assembly 300.

As described in U.S. Pat. No. 6,735,874 B2, the upper surfaces of the lower row of tangs 330 are flat or generally planar.

As noted above, with the design as shown in FIG. 1 of U.S. Pat. No. 6,735,874 B2, it is possible, under certain conditions of speed and load, that the flat surfaces of the lower row of tangs 330 and the flat surfaces of the follower tangs 308, under the action of a compression spring, may cause the follower member to be lightly stuck in the upward position and, thus, interfere with the advancing of the trimmer line out of the trimmer head.

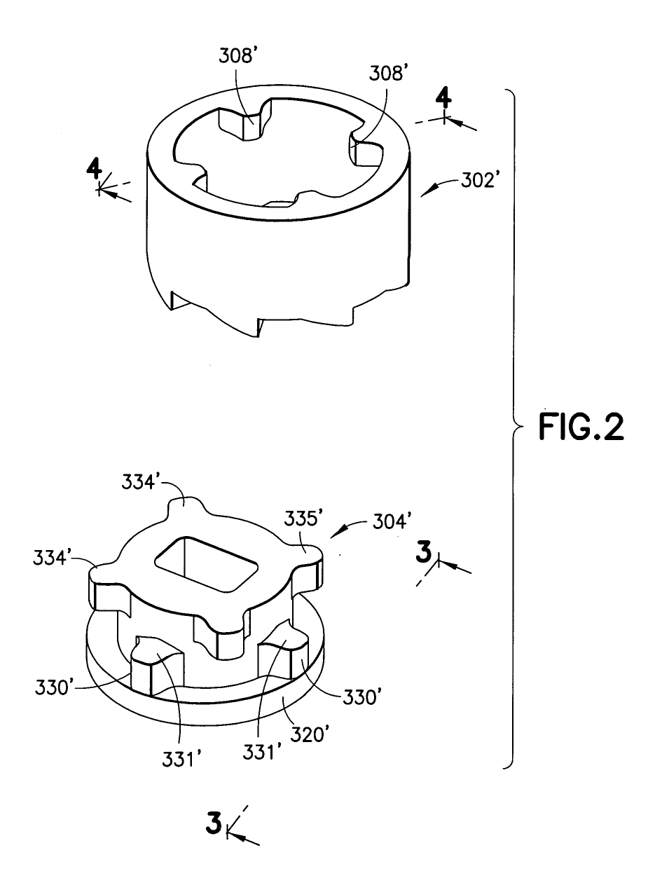

In order to obviate the above-mentioned possible problem, the subject invention, as illustrated in FIGS. 2-9, provides that the upper surfaces of the lower row of cam tangs 330′ and the lower surfaces of the follower tangs 308′ have curved or domed surfaces, as contrasted to the planar surfaces in the prior art. As illustrated in FIG. 2, the cam member 304′ has radially outwardly oriented tangs 330′ which include upper curved surfaces 331′.

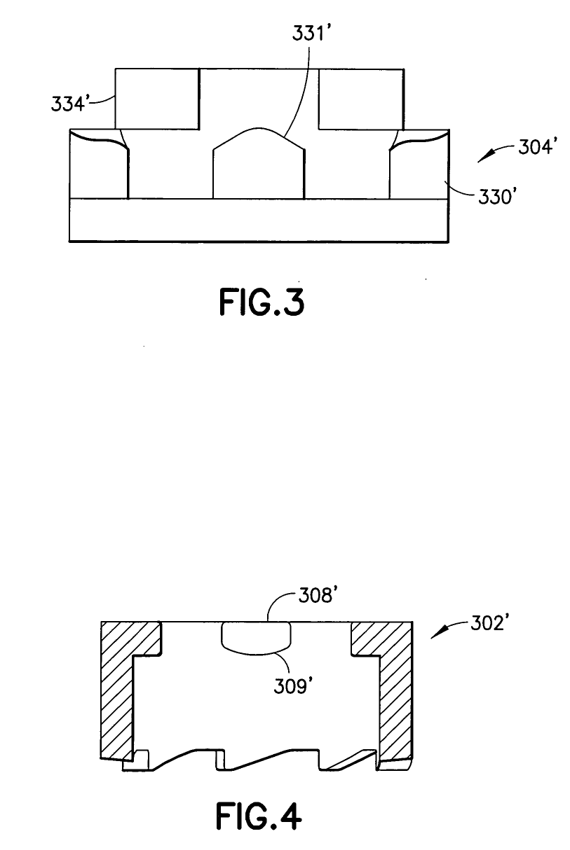

The upper curved or domed surfaces 331′ of the lower row of cam tangs 330′ is illustrated in FIG. 3 which is a side elevational view of the cam 304′. Each upper curved surface preferably includes two downwardly inclined surfaces disposed at approximately a 60° angle to the vertical axis. The inclined surfaces meet at the apex which is rounded, preferably at a radius of 0.125 inches, as illustrated in FIG. 3. Note that the upper tangs 334′ of the cam member include planar upper and lower surfaces designated by the numerals 335′ and 336′.

Turning to FIG. 4, the lower surface 309′ of each follower tang 308′ of the follower member 302′ is also curved or domed. Preferably the entire lower bearing surface of each follower tang is arcuate, at a radius of approximately 0.256 inches, as illustrated in FIG. 4.

FIG. 5 illustrates the follower and cam members as viewed from the bottom side thereof.

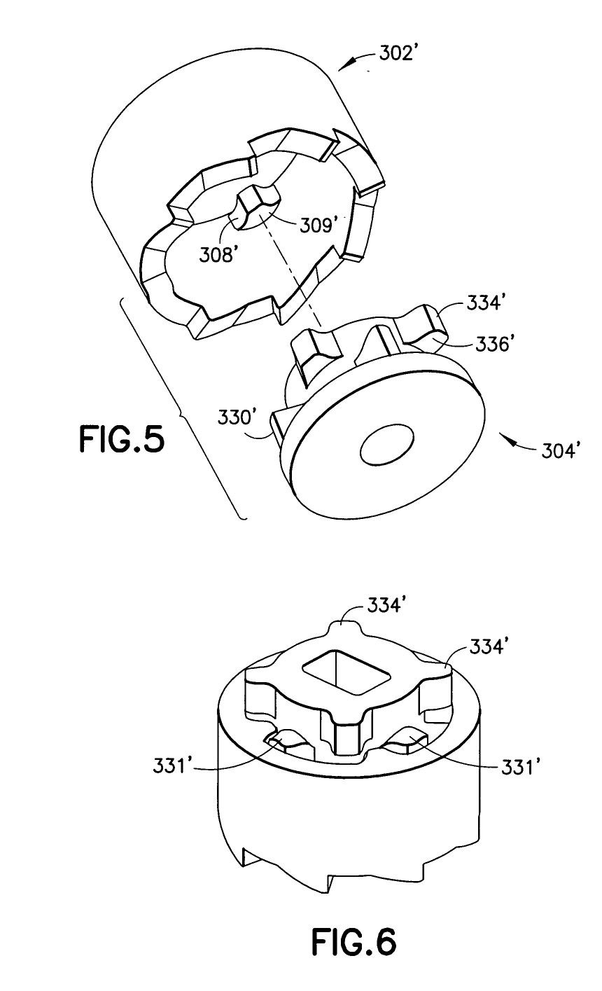

FIG. 6 illustrates the normal driving position of the advancing assembly of the subject invention, wherein the lower tangs 330′ of the cam member 304′ are engaged with the sidewalls of the upper tangs 308′ of the follower member 302′.

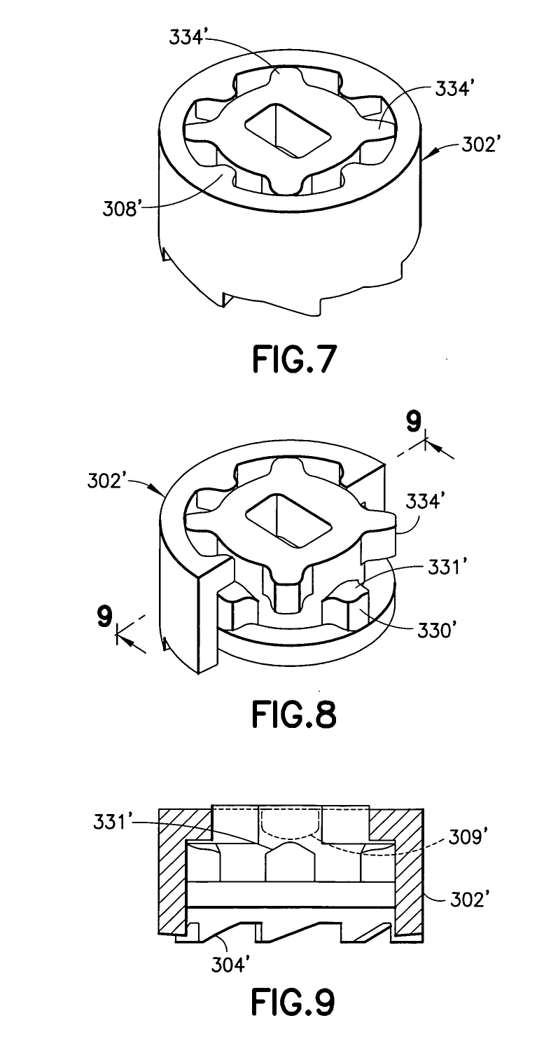

Turning to FIGS. 7, 8 and 9, in FIG. 7 there is illustrated the midpoint of the advancing system of the subject invention wherein the follower is in the upward position. At such time, the lower curved surfaces 309′ of the follower tangs 308′ are in engagement with the curved upper surfaces 331′ of the lower row of tangs 330′ of the cam 304′. At that point, the respective curved tangs, in engagement, are actually in line engagement and, thus, there is slight chance that the respective members would be stuck in the upward position and hinder the advancement of the flail.

With the follower member in the upward position as illustrated in FIGS. 7-9, there is additional compression on the spring which is normally pushing lightly downward on the follower member 302′. Because of the curvature on the lower surface of the follower tang 308′ and the curvature on the upper surface 335′ of the lower row of cam tangs 330′, it becomes nearly impossible for the follower to become stuck in the upward position, as was the occasion in the prior art design when these surfaces were flat and perpendicular to the vertical axis.

Because of the curved surfaces in the subject invention, as particularly depicted in FIG. 9, the downward force of the compression spring acting on these curved surfaces now forces the follower to continue rotating so it can complete the flail line advancement operation and return to its downward position.

Because both the lower row of the cam tangs and the follower tangs are curved as described above, it now becomes extremely unlikely for the follower member to come to rest in a position that would allow the follower member to set on top of the upper surface of the lower curved row of cam tangs. It is still theoretically possible, even with the subject design, that the follower tangs could come to rest on top of the cam tangs if the two curved surfaces were exactly centered, with one above the other as shown in FIG. 9. However, in actual practice, this does not occur since now, even the tiniest amount of torsional vibration caused by the engine, which is always present in the trimmer machine, can sufficiently bump the angular position of the follower member relative to the cam member such that the two curved surfaces are no longer in line contact and exactly centered one above the other. Once these two surfaces are no longer in line contact, they act as ramps allowing the downward force of the compression spring to force the follower to continue its rotation until the follower tangs have completely slid off the top of the lower row of cam tangs to the position as illustrated in FIG. 6.

Another equally important benefit of the subject invention is that the curved surfaces make it easier for the follower to accomplish its first few degrees of rotation immediately after the initial upward movement which initiates the flail line advancement operation. In other words, the follower tangs now make the transition up and on top of the lower row of the cam tangs much easier than before. This is because, in the subject invention, plastic has been removed from the lower corners of the follower tangs and from the upper corners of the lower row of cam tangs, in order to convert the prior art flat surfaces into curved surfaces. This removal of plastic from where it used to be has created additional clearance space for the mechanism, greatly improving its freedom of movement and with almost no sacrifice in the strength of the tangs.

It should also be noted that the design changes of the subject invention were accomplished with only a slight modification to existing tooling, and the cost of manufacture is practically unchanged. Indeed, less plastic is used, and there is a possible small savings because of that factor.

Thus, there has been shown and described an improved automatic flail feedout mechanism which fulfils all of the objects and advantages sought therefor. Many changes, modifications, variations and other uses and applications of the subject invention will, however, become apparent to those skilled in the art after considering the foregoing specification together with the accompanying drawings. All such changes, modifications, variations and other uses and applications which do not depart from the spirit and scope of the invention are deemed to be covered by the invention.

What is claimed is:

1. A cutting head for a rotary trimmer having two diametrically opposed cutting flails which extend outwardly from a spinning assembly including two major assemblies, a cap assembly and a spool assembly having an axis of rotation, a bumper for engagement with the ground and means to allow predetermined lengths of flail to feed outwardly in response to the striking of the bumper on the ground, the improvement comprising:
a cam member having a cam slot therein connected to one of said assemblies, said cam slot being a serpentinous cam slot having one portion formed by the radial surface of a washer, said cam slot being defined by radially extending tangs which are radially spaced, with alternate tangs being spaced along said axis of rotation so as to define said serpentinous cam slot, each said tang being of truncated, bell-shaped configuration so as to avoid stress concentrations, said cam slot being further defined by an upper row of tangs and a lower row of tangs spaced along said axis of rotation, with the upper surfaces of the lower row of cam tangs being curved;
a follower member connected to the other of said assemblies and having diametrically opposed cam followers thereon positioned to ride in said cam slot, said follower member further including six outwardly extending knobs, said spool assembly surrounding said follower member and having six grooves extending parallel to said axis of said spool assembly, said grooves having parallel sidewalls, with two diametrically opposed grooves having lateral cutouts at the lower ends thereof for receiving two of said knobs, said two of said knobs being positioned in said lateral cutouts to releasably retain said follower member to said bumper;
said cam follower of the follower member being defined by four radially spaced tangs extending radially inwardly of said follower member, each said tang being of truncated, bell-shaped configuration for minimizing stress concentrations when said cam follower is engaged in said cam slot, and wherein the lower surface of each said cam follower tang is curved such that the engagement of the lower curved surfaces of the tangs of the cam follower and the upper curved surfaces of the tangs of the lower row of the cam slot results in a smoother operation of the cutting head; and
biasing means acting between said cam member and said follower member tending to urge said cam follower into stable positions on said cam slot when undisturbed by force applied to said bumper and adapted to be overcome by suitable force applied to said bumper, said cam slot being generally parallel to the force applied by said biasing means.

2. A cutting head for a rotary trimmer as in claim 1 wherein each curved surface of the cam tang includes two downwardly inclined flat surfaces which are joined at the apex of the cam tang with a radius arcuate surface.

3. A cutting head for a rotary trimmer as in claim 2 wherein the radius arcuate surface has a radius of 0.125 inches.

4. A cutting head for a rotary trimmer as in claim 1 wherein each curved surface of the follower tangs has a radius of 0.256 inches.
